(19) United States
(12) Patent Application Publication
(10) Pub. No.: US 2004/0207123 A1
(43) Pub. Date: Oct. 21, 2004

(54) 3-D model maker

(76) Inventors: Ranjana Patel, Herts (GB); Richard J. Peace, Bedford (GB)

Correspondence Address: PROSKAUER ROSE LLP, PATENT DEPARTMENT, 1585 BROADWAY, NEW YORK, NY, 10036-8299, US

(21) Appl. No.: 10/468,329

(22) PCT Filed: Feb. 12, 2002
(86) PCT No.: PCT/GB02/00595

(30) Foreign Application Priority Data
Feb. 16, 2001 (GB) 0103752.2

(51) Int. Cl. B29C 35/04

(52) U.S. Cl. 264/401

(57) ABSTRACT

A process for forming a three-dimensional article in sequential layers in accordance with a digital model of the article. The process comprises the steps of defining a layer of a first liquid, applying a second liquid to the first liquid layer in a pattern corresponding to the digital model, and repeating these steps to form succesive layers. The first liquid comprises a first active component and the second liquid includes a second active component capable of reacting with the first reactive component so that the article is built up in layers.

The present invention relates to three-dimensional printing, more specifically, a method of forming 3-D objects by printing techniques using computer models.

The process involved in manufacturing articles or parts is undergoing a considerable streamlining of workflow, enabled by the advent of high speed desktop computing with high processing capability, versatile CAD software able to create and represent 3-D objects, and high speed transmission of created digital files for global distribution. Within this developing scenario, it is of growing importance to have the ability to translate the created three dimensional digital files into handleable objects which truly represent or “proof” the digital files. This is particularly so when the created objects actually have the functionality of the objects which are to be manufactured, ultimately.

“Rapid Prototyping” systems were devised several years ago to provide such capability. In particular, stereolithography has developed as a technique capable of creating high accuracy 3-D objects using layerwise digital curing of photopolymers. This has developed significantly as a pioneering technology to produce three dimensional objects from CAD files, using UV lasers and photosensitive liquid photopolymerisable resin mixtures; however, the equipment is at present expensive and requires expert users.

An example of this can be found in U.S. Pat. No. 4,575,330. In this case, a digital representation of a 3-D object is taken and converted into a succession of digital laminae. A thin layer of a UV photosensitive curable liquid resin is formed on a platform and this is cured in the desired pattern using a UV source directed to the appropriate positions on the liquid layer in accordance with the digital representation of the respective lamina. This is then repeated. A problem with this system is that it is restricted in the materials available and does not readily allow for variations in the composition of the object.

Another existing technique (U.S. Pat. No. 4,863,538) which is in some ways similar, is the laser sintering of successive powder layers. Examples of another system can be found in U.S. Pat. No. 5,204,055 and U.S. Pat. No. 5,340,656. These describe applying a liquid to successive powder layers in order to bond the powder layers in the required pattern. In U.S. Pat. No. 5,807,437, the liquid is applied effectively using inkjet nozzles which enable variable deflection of the liquid droplets. A drawback of those systems is that the object produced can be delicate and prone to damage. For this reason, a major application is to use the 3-D models produced from ceramic or metallic/organic composite powders to make tools after furnace firing to remove organic binders.

A more recent development is the hot-melt system, described in U.S. Pat. No. 5,855,836. In this case a solid formulation (“phase change”) is heated until it melts and is jetted in a desired pattern on to a substrate. It then cools and solidifies, and the sequence is repeated to build a 3-D object. The formulation includes a reactive component which is finally activated to cure the object. A disadvantage here again is that the materials available are extremely limited.

It is an object of the present invention to provide a process for forming a 3-D object which does not suffer the drawbacks of the prior art systems. More specifically, the invention seeks to provide a method—which can produce an object which is robust and which can have varying properties.

According to one aspect of the invention, there is provided a process for forming a three-dimensional article in sequential layers in accordance with a model of the article, the process comprising the steps of: defining a layer of a first liquid material; applying a second liquid to the first liquid layer in a pattern corresponding to the model; and repeating these steps to form successive layers; and in which the first liquid includes a first active component and the second liquid includes a second active component capable of reacting with the first reactive component liquid. The second liquid preferably has a viscosity in the range of 2 to 500 cps at room temperature.

Thus, the two reactive components react on contact to form a solid lamina in the required pattern and this is repeated to form a solid article. In this specification, a solid or 3-D article is one formed of four or more layers.

It has been found that the system according to the invention allows the formed article to be relatively robust since the active components react chemically to form a new chemical component. Chemical bonds can also form between layers.

The first and second active components may comprise respective mixtures of active compounds.

Preferably, the first active component and/or the second liquid substantially comprises the second active component. Preferably the second liquid includes a proportion of the first liquid and/or first active component(s). Preferably, the model is a digital model.

Preferably, the second liquid additionally comprises a viscosity lowering diluent in order to achieve the desired viscosity. The effect of the low viscosity of the second liquid is that it enables the second liquid to be jetted out of smaller bore nozzles, without the need to raise the temperature, thereby achieving a superior resolution. Furthermore, better mixing of the first and second liquids will be effected by having the diluent.

Benefits of layer wise build up of objects from a flowable/coatable first liquid include the self support of the forming programmed object by the liquid and furthermore the unused liquid can be reused.

Different liquid formulations may be used as the second liquid, either at different locations on the same layer or on different layers. Conveniently, the liquid is applied using a linear array of nozzles which are passed over the first liquid layer. Thus different liquids can be supplied to different nozzles and/or different liquids can be applied in respective sequential passes, either over the same liquid layer or succeeding layers.

The layerwise construction of the three dimensional object can thus be such that different liquids maybe jetted/sprayed imagewise during each layer construction or in different whole layers or multi-layers, thus affording differing micro and macro properties of strength and flexibility. Random or repeating programmed patterns may be formed to achieve smooth, void free final properties. Other liquids may be jetted/sprayed over the previous, already jetted areas.

It may also be possible to incorporate an entirely “foreign” body within the structure, for example conducting tracks or metallic components/devices, or to incorporate a foreign liquid, for example a micro-encapsulated formulation of liquid crystal systems. The conducting tracks, or metallic components/devices may themselves be produced in situ in the layers using secondary jets dispensing molten or conducting organic materials.

The process may include a further step of irradiating the article. The article may be irradiated pixel by pixel, line by line or layer by layer, and/or after several layers have been formed, and/or after all the layers have been formed. Preferably, electromagnetic radiation is employed. Suitable sources include UV light, microwave radiation, visible light, laser beams, and other similar sources.

The nozzle system employed is preferably equivalent or identical to that used in inkjet systems, preferably piezo inkjet or spray systems. Preferably, the size of the nozzle openings is the range 10 to 100 μm and/or the size of the applied droplets is in the range 1 to 200 μm. Preferably, the process includes the step of varying the number of pixel drops and/or varying the applied liquid per pixel, per line applied and/or per layer, in order to achieve variable properties in the article.

By combining the compositions with programmable piezo printhead technology, it is possible to vary micro-material properties of the formed object, to achieve strength, texture and variable macro properties required in actual functional 3D objects. As Pixel addressability with piezo printheads can be as high as 20 micron spots and will approach even higher addressability, the resulting resolution can match the resolution achievable using laser address systems.

Highly precise objects can be fabricated with fine detail. Different fluids/components can be dispensed pixel-wise, line wise and layer wise within these address schemes, with farther differentiation possible through clustering in the pixels, lines and layers in a random or configured manner, to provide even more material property variation from flexible, elastic and conformable, to rigid and toughened. In addition to differential material properties (mechanical and texture), true and accurate colour rendition in the formed object is available by incorporating colourants in the dispensing liquids. Optical properties may also be varied, for example selective wavelength refractive/transmissive properties can be produced in random or patterned way.

Furthermore, the layers can be of different thicknesses and each layer can itself be formed with a prescribed topography by varying its thickness over its extent. The topography between and in layers can be patterned, thus achieving optical or mechanical effects. The patterns (optical, electro, or integral electro-optical) can be planar (ie. within a layer) or can be 3-Dimensionally disclosed circuit within the laminar structure.

Typically, the formed layer may be up to 300 μm in thickness, though more commonly they might be up to 200 μm. Thin layers down to 80 μm or 50 μm may be achieved and possibly even thinner layers of 30 μm or 20 μm, or down even to 1.0 μm.

However to achieve these capabilities via the use of the arrays of adjacent nozzle jets, it is desirable in the first instance to have low viscosity fluids (less than 40 cps with 2-30 cps preferred at ambient temperatures), which can be jetted at high jet firing frequency (preferably 10 to 30 KHz line frequency and preferably 60-100 KHz individual jet frequency).

Preferably, diluents are added to the second liquid to reduce the viscosity from over 30 cps to below 15 cps. Reactive diluents are highly preferred as these will become incorporated into the finally formed 3D object, such that there is not present any subsequent vapour emission and/or free liquid.

Preferably, the first active component comprises resins such as ring opening compounds, eg. epoxy, polyepoxy, thiiranes, aziridines, oxetanes and cycloaliphatics; polymerising compounds such as vinyl, ethylenic and (metha) acrylate, hydroxyacrylates, urethane acrylates and polyacrylates; hybrid compounds, such as epoxy-acrylates, isocyanurate-epoxy, Epoxy-Silane advanced resins and PU-silanes; and condensing resins such as isocyanates. The resin layers may additionally contain fillers, reactive or not, organic (eg. core shell), inorganic (glass spheres/fibres/flakes, alumina, silica, calcium carbonate etc), pigments, dyes, plasticisers, pore formers etc.

Toughener materials such as those described in U.S. Pat. No. 5,726,216 may be added to the first liquid or introduced selectively via the second fluid in the programmed jetting procedure.

Preferably, the second active component is a radiation photosensitive radical and/or cationic photoinitiator and/or a catalyst. The active component in the second liquid may comprise nano particles, either directly reactive via surface groups (such as epoxy, acrylic, hydroxy, amino etc) or contained as dispersions in an active component.

The curable/polymerising/crosslinkable liquids can involve compounds which can undergo condensation reactions triggered either by thermosetting reactions such as epoxy/amine types or by electromagnetically released cationic systems such as epoxy plus sulfonium, iodonium, ferrocenium salts, or radical systems such as acrylates plus radical photoinitiators eg. benzophenone, Irgacure 184, thioxanthone, alkylborates etc. In the former case, the reactants can be separately included in the two liquids such that on jetting, the two components react to form the condensation product. In the latter case, electromagnetic radiation can be administered imagewise in synchronisation with the liquid jet activation, pixel, line or overall whole layer wise irradiation. Initiators comprising two components, one component in each fluid, may also be employed such that on jetting the active initiating species is formed.

The active components can be epoxy, acrylic, amino, hydroxy based compositions, as neat liquids, diluted liquids or as emulsions in water. In case of electromagnetically activated crosslinldng reactions, the second liquid may contain electromagnetic sensitive compounds, such that on jetting the second liquid, the electromagnetically active compound releases the crosslinking activator, eg. a radical or acid or base.

One or both liquids may contain nanoparticles. The nanoparticles can be reactive or not, organic (from micro-emulsions), organo-metallic, ceramic, colloidal metallic/allow, and may be stabilised suspensions in the resin of choice.

The viscosity of the first liquid can be from 30 to over 30,000 cps at room temperature and then, with higher viscosity liquids, have a much lower viscosity at higher operational temperatures. The lower viscosity at higher temperature may be utilised for faster recoating of the layers of the first liquid making up the final 3-D product, as well as to remove the unused first liquid.

Preferably, the viscosity of the second liquid composition is low, eg. 2 to 20-30 cps, at room temperature to be compatible with current array piezojet systems. More preferably, the viscosity is 10-20 cps as a reasonable balance of fast jetting/spraying piezo action, combined with good resolution. Too low a viscosity can lead to loss of resolution due to excessive image spread.

Thus catalysts (eg. initiators for condensing or crosslmldng or polymerising) dissolved or dispersed in the reactive low viscosity second fluid maybe jetted onto resin compositions (layer viscosity ranging between 30 to more than 30,000 cps) of the first liquid to cause pixel wise condensation of the resin.

A higher viscosity for the second liquid (ie. greater than 500 cps at room temperature) may be useful for jetting paste-like droplets on and into the first liquid such that the paste droplet becomes a toughening additive in the resin layer. The paste may be reactive or not. Similarly for example, molten metallic or organic conducting or semi-conducting polymers may be directly jetted onto/into the first liquid.

Simultaneous electromagnetic irradiation may be used in case of using photo-active catalysts. Viscosity lowering in this case is achieved by using low viscosity reactive components (eg. oxetanes such as UVR6000 from UCB) and diluents (eg. polyols),. which can furthermore participate in the photo-catalysed polymerisation/condensation reaction. Alcohols aid efficient photolysis of cationic ions used for cationic polymerisation of epoxy compounds.

Most surprisingly, it has been found that small amounts of first active component or liquid present in the jetted low viscosity second liquid, for those systems with simultaneous electromagnetic irradiation, greatly aids control of the reaction. It is believed that this is due to improved surface tension matching between the jetted fluid and the liquid layer, as well as a more rapid and higher incorporation, with resolution, of the jetted catalyst into the first liquid layer.

The jetted liquid can be jetted or micro-sprayed. Two or more liquids may be jetted or sprayed simultaneously from adjacent jetting or spraying printheads such that the liquids combine either in flight or on the surface of the first liquid. This process is particularly useful for jetting/spraying traditional two component adhesive resin mixtures, which have to be held separately until in use.

Preferably, any diluent in the second liquid is present in the range 20 to 50% by volume, more preferably to 20 to 30%. Preferably the thickness of the first liquid layer is in the range 0.1 to 200 μm, more preferably 0.1 to 100 μm.

In one preferred system, the first liquid is contained within an enclosure and the article is formed on a platform within the enclosure. As each successive layer is formed, the platform is lowered into the enclosure and so into the supply of the first liquid. In this way, the article is supported by the first liquid while it is being formed. After a lamina has been formed in the required pattern, the platform may be lowered to a significantly lower level within the first liquid and then raised to the required level, thereby picking up a quantity of the first liquid. The first liquid can then either be levelled off to the required thickness, eg. by a blade, or may be allowed to find its own level and thickness.

After 3 dimensional construction, the excess liquid is drained off, and the part is preferably post-cured, either thermally or by using electromagnetic irradiation (eg. UV, visible, infra red, microwave etc).

The process lends itself very conveniently to the production of articles from a digital representation held by a computer, and is particularly suitable for use with CAD systems. Thus, an article can be designed using CAD software, the digital information can be converted to a series of laminae in digital form and the digital representation of the laminae can be used to control the delivery of the second liquid sequentially on to successive layers of the first liquid, in order to reproduce the article in 3-dimensions. The techniques can be used for rapid prototyping and even rapid manufacture.

The produced object can be used as an actual technically functional part or be used to provide a proof of the CAD files before actual production. The technique is also suitable for in-line production use as layered encapsulants in the electronic field, printed optics, and for verification of digital files. The technique may also be useful in forming multi-layer structured films with polarising optical or wave guiding effects.

It will be appreciated that by using the techniques of the present invention, it is possible to build up three dimensional articles in the form of laminated blocks or items with complex shapes. By varying the characteristics across the layers including layer thickness, as they are formed, optionally on a micro-scale, it is possible to instil at least a functionality in the finished article. This functionality can take many forms, examples of which include electronic circuits and optical components. In the case of electronic circuits, the techniques of the invention offer a method of producing intricate circuits of microscopic size. Preformed circuits can be embedded in the layers. In the case of optical components, the invention enables the optical properties of a component to be varied layer by layer and across each layer, and each layer can be of varying thickness, thereby enabling complex optical multi-layer films to be produced.

It is also possible to build the component on to a substrate which is then retained as part of the final finished article. Such a substrate might be a glass or a plastics sheet which could for example form part of an optical component.

The invention may be carried into practice in various ways and some embodiments will now be described by way of illustration in the following Examples.

In the following examples, the materials used are:

| Material | Supplier | Description |
|---|---|---|
| SL7540 | Vantico Ltd | Epoxy/acrylate stereolithography |
| | | resin |
| SL7540 with no | | Same composition as SL7540 with |
| initiators | | the absence of photoinitiators |
| UV16974 | Union Carbide | Cationic photoinitiator |
| IR184 | Ciba | Free-radical photoinitiator |
| Oracet Blue | Ciba | Blue dye |
| UVR6000 | Union Carbide | 3-ethyl-3-hydroxymethyl-oxetane |
| SR399 | Cray Valley | Pentaacrylate |
| MEK | | Butanone |
| IPA | | Propan-3-ol |

### EXAMPLE 1

The test resin (0.35 g) was placed in an aluminium dish (55 mm diameter), spread with a spatula and allowed to settle to give an even layer approximately 200 μm deep. An initiator droplet (2.5 μl) was added by syringe, allowed to stand for a period of time T, and cured by passing under a UV lamp (Fusion Systems F450, 120 Wcm⁻¹) on a conveyor (Speed 6.5 m/min (corresponding to 3.8 s exposure)). After curing, subsequent layers were produced by the addition of a further 0.35 g of resin and the procedure repeated with the deposition of drops of initiator over the initial cured spots.

The procedure was repeated using different resins and different initiators. The results are set out in Table 1.

TABLE 1

| Entry | RESIN LAYER | FLUID DROPS | Layers | Result/Comment |
|---|---|---|---|---|
| 1 | SL 7540/No | 71.4% UVI 6974 | 3 | Difficult to get layers |
| | Initiators | 26.6% IR 184 | | to overlap - 2nd and |
| | | Trace Oracet Blue | | 3rd droplet run off |
| | | | | previous layer. Layers |
| | | | | bonded at centres. |
| | | | | T ≧ 6 min required for |
| | | | | full curing of spots |
| 2 | SL 7540/No | 35.7% UVI 6974 | 3 | Spots spread less than entry 1 |
| | Initiators | 14.3% IR 184 | | and superimpose well. |
| | | 50% SL 7540 (No | | Layers firmly bonded. |
| | | initiators) | | Spots fully cured for T ≧ 2 min |
| | | Trace Oracet Blue | | (shorter times not investigated) |
| 3 | SL 7540/No | 64.3% UVI 6974 | 3 | Spots spread rapidly |
| | Initiators | 25.7% IR 184 | | and unevenly, difficult |
| | | 10% MEK | | to get spots to overlap. |
| | | | | Layers do not bond |
| | | | | well. Spots fully cured |
| | | | | for T ≧ 2 min (shorter |
| | | | | times not investigated) |
| 4 | SL 7540/No | 35.7% UVI 6974 | 3 | Spots spread faster |
| | Initiators | 14.3% IR 184 | | than entry 2, but layers |
| | | 50% UVR 6000 | | superimpose well and |
| | | Trace Oracet Blue | | bond firmly. T = 5 min |
| 5 | Epoxy | UVI 6974 | 1 | Resin dewets from |
| | components of | | | aluminium at location |
| | SL 7540 | | | of droplet producing a |
| | | | | ring on curing |

### EXAMPLE 2

The resin was placed in an aluminium dish (diameter 55 mm), spread with a spatula, and allowed to settle. The sample was placed on a conveyor moving at 6.5 mmin⁻¹ and a continuous stream of the appropriate jet fluid sprayed (viscosity=15 cps) onto the resin from a piezo inkjet printhead by MIT available from Euromaric Coding and Marketing Ltd. manual triggering. The resin was cured immediately by passing under a UV lamp (Fusion Systems F450, 120 Wcm⁻¹) on a conveyor (speed 6.5 m/min (corresponding to 3.8 s exposure)). Subsequent layers were formed by the same procedure.

The procedure was repeated using different resins and different initiators. The results are shown in Table 2.

TABLE 2

| | | | Mass | |
|---|---|---|---|---|
| | | | of resin | |
| | RESIN | | per | |
| Entry | LAYER | JET FLUID | layer | Result/Comment |
| 1 | SL 7540 | 29.4% UVI 6974 | 0.35 g | Thin layers produced |
| | with no | 29.4% UVR 6000 | | which do not bond |
| | initiators | 29.4% IPA | | together |
| | | 11.8% IR 184 | | |
| 2 | SL 7540 | 29.4% UVI 6974 | Layer 1. | Thin layers produced |
| | | 29.4% UVR 6000 | 0.35 g | which bond but can be |
| | | 29.4% IPA | Layer 2. | peeled apart easily. |
| | | 11.8% IR 184 | 0.20 g | After further UV |
| | | | Layer 3. | curing (3 more passes |
| | | | 0.20 g | under UV light) layers |
| | | | | are firmly bonded |
| 3 | SL 7540 | 33.3% UVI6974 | 0.35 g | Thin layers produced |
| | epoxy only | 33.3% UVR6000 | | which do not bond |
| | components | 33.3% IPA | | together |
| 4 | SL 7540 | 25.6% UVI 6974 | 0.35 g | Thin layers produced |
| | with no | 25.6% UVR 6000 | | which do not bond |
| | initiators | 25.6% IPA | | together |
| | | 12.8% SR 399 | | |
| | | 10.3% IR 184 | | |
| 5 | SL 7540 | 57.7% UVI 6974 | Layer 1. | Thin layers produced |
| | with no | 19.2% Butyl | 0.35 g | which bond but can be |
| | initiators | Lactone | Layer 2. | peeled apart easily. |
| | | 23.1% IR 184 | 0.20 g | After further UV |
| | | | Layer 3. | curing (3 more passes |
| | | | 0.20 g | under UV light) layers |
| | | | | are firmly bonded |

### EXAMPLE 3

This Example addresses more specifically the effects of varying the liquid layer and the jetted liquid. The resin was placed in an aluminium dish (diameter 55 mm), spread with a spatula, and allowed to settle. The sample was placed on a conveyor moving at 6.5 mmin⁻¹ and a continuous stream of the appropriate jet fluid sprayed by manual triggering onto the resin from a piezo inkjet printhead from MIT. The resin was cured immediately by passing under a UV lamp (Fusion Systems F450, 120 Wcm⁻¹) on a conveyor (speed 6.5 m/min (corresponding to 3.8 s exposure). Subsequent layers were formed by the same procedure.

Entry 1 shows change in layer type.

Entry 2 shows change injet fluid type.

The results are set out in Table 3.

TABLE 3

| | | RESIN | | Mass of | Result/ |
|---|---|---|---|---|---|
| Entry | Layer | LAYER | JET FLUID | resin | Comment |
| 1 | 1 | SL 7540 with no | 29.4% UVI 6974 | 0.35 g | |
| Variable | | initiators | 29.4% UVR 6000 | | |
| Layers | | | 29.4% IPA | | |
| | | | 11.8% IR 184 | | |
| | 2 | UVR 6000 | As above | 0.20 g | |
| | 3 | SL 7540 with | As above | 0.20 g | Layers bonded but |
| | | no initiators | | | can be peeled apart. |
| | | | | | Firmly bonded on |
| | | | | | further UV exposure |
| 2 | 1 | SL 7540 with | 29.4% UVI 6974 | 0.35 g | |
| Variable | | no initiators | 29.4% UVR 6000 | | |
| Jet Fluid | | | 29.4% IPA | | |
| | | | 11.8% IR 184 | | |
| | 2 | As above | 25.6% UVI 6974 | 0.20 g | |
| | | | 25.6% UVR 6000 | | |
| | | | 25.6% IPA | | |
| | | | 12.8% SR399 | | |
| | | | 10.3% IR184 | | |
| | 3 | As above | 29.4% UVI6974 | 0.20 g | Layers bonded but |
| | | | 29.4% UVR6000 | | can be peeled apart. |
| | | | 29.4% IPA | | Firmly bonded on |
| | | | 11.8% IR 184 | | further UV exposure |

As seen above, it is possible to change both the liquid layer and jetted liquid between each layer address. Thus the ink jet process allows considerable variability of properties by being able to change both the receptor layer and the jetted liquid.

A new and different receptor liquid could be dispensed by inkjet process itself, in a layer wise manner or otherwise, with the programmed jetted liquid following the layer depositing jets.

1. A process for forming a three-dimensional article in sequential layers in accordance with a model of the article, the process comprising the steps of. defining a layer of a first liquid material; applying a second liquid to the first liquid layer in a pattern corresponding to the model; and repeating these steps to form successive layers; and in which the first liquid includes a first active component and the second liquid includes a second active component capable of reacting with the first reactive component, the second liquid having a viscosity in the range of 2 to 5 00 cps at room temperature.

2. A process as claimed in claim 1, in which the first liquid substantially comprises the first active component and/or the second liquid substantially comprises the second active component.

3. A process as claimed in claim 2, in which the second liquid includes a proportion of the first liquid and/or first active component.

4. A process as claimed in claim 3, in which the model is a digital model.

5. A process as claimed in claim 4, in which the first and/or second active components comprise respective mixtures of active components.

6. A process as claimed in claim 5, in which the second liquid additionally comprises a viscosity lowering diluent in order to achieve the desired viscosity.

7. A process as claimed in claim 6, in which the second liquid has a viscosity in the range 2 to 30 cps at ambient temperature.

8. A process as claimed claim 7, in which the second liquid is applied through a plurality of nozzles.

9. A process as claimed in claim 8, in which the nozzles form part of an inkjet printer or a device including a set of nozzles generally equivalent to an inkjet print head.

10. A process as claimed in claim 9 in which the nozzles operate on the principles of piezo inkjet technology.

11. A process as claimed in claim 10 in which the size of the nozzle openings is the range 10 to 100 mm and/or the size of the applied droplets is in the range 1 to 200 mm.

12. A process as claimed in claim 10, in which the size of the nozzle openings is in the range 0.1 to 100 mm and/or the size of the applied droplets is in the range 0.1 to 200 mm

13. A process as claimed in claim 12, in which a plurality of different liquids is applied to respective layers of the first liquid.

14. A process as claimed in claim 13, in which a plurality of different liquids is applied to a single layer of the first liquid, in the same or in different locations.

15. A process as claimed in claim 14, in which the different liquids are applied in a single pass.

16. A process as claimed in claim 14, in which the different liquids are applied in respective sequential passes,

17. A process claimed in claim 16 any preceding claim, in which the layers formed have differing thicknesses.

18. A process as claimed in claim 17, in which a layer is formed with a varying thickness over its extent.

19. A process as claimed in claim 18 any preceding claim, further including the step of irradiating the article.

20. A process as claimed in claim 19, in which the article is irradiated, pixel by pixel, line by line or layer by layer.

21. A process as claimed in claim 19, in which the article is irradiated after several layers have been formed.

22. A process as claimed in claim 19, in which the article is irradiated after all the layers have been formed.

23. A process as claimed, in which the irradiating step employs electromagnetic radiation.

24. A process as claimed in which the irradiating step employs UV radiation.

25. A process as claimed in claim 24, including the step of varying the -number of pixel drops and/or varying the applied liquid per pixel, per line applied and/or per layer, in order to achieve variable properties in the article.

26. A process as claimed in claim 25, in which the first liquid comprises a curable cross-linkable or polymerisable compound and the second liquid comprises an initiator.

27. A process as claimed in claim 26, in which the first active component is selected from: resins such as ring opening compounds, eg epoxy, polyepoxy, thiiranes aziridines oxetanes and cycloaliphatics polymerising compounds such as vinyl, ethylenic and (metha) acrylate, hydroxyacrylates, urethane acrylates and polyacrylates; hybrid compounds, such as epoxy-acrylates, isocyanurate-epoxy, Epoxy-Silane advanced resins and PU-silanes condensing resins such as isocyanates; and mixtures thereof.

28. A process as claimed claim 27, in which the first and/or second liquid contains an organic or inorganic filler, pigments, nanoparticles, dyes, surfactants and/or dispersants

29. A process as claimed claim 28, in which the first and/or second liquid is coloured.

30. A process as claimed claim 29, in which the second active component is a radical and/or cationic photoinitiator and/or a catalyst.

31. A process as claimed claim 30, in which the first reactive component represents essentially 100% of the first liquid.

32. A process as claimed claim 31, in which the second active component represents 1 to 80% of the second liquid.

33. A process as claimed claim 32, in which the thickness of the applied layers from first liquid is in the range 0.1 to 200 gm.

34. A process as claimed claim 33, in which the thickness of the formed layer is from 1.0 gm to 200 gm.
